(19) United States
(12) Patent Application Publication
(10) Pub. No.: US 2006/0069613 A1
(43) Pub. Date: Mar. 30, 2006

(54) System for partial automation of content review of network advertisements

(75) Inventor: Marion Louise Marquardt, Cambridge (GB)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/952,666

(22) Filed: Sep. 29, 2004

(51) Int. Cl. G06Q 30/00

(52) U.S. Cl. 705/14

(57) ABSTRACT

Upon receiving a proposed network advertisement from an advertiser, a publisher determines whether to automatically approve the proposed advertisement for publishing, automatically reject the proposed advertisement from being published, or manually verify the content of the proposed advertisement prior to publishing based on a distribution channel of the proposed advertisement, a trust rating of the advertiser, a business rule, or expected traffic of a location at which the proposed advertisement is to appear.

### BACKGROUND OF THE INVENTION

1. Field of the Invention

The present invention generally relates to Internet advertising. More specifically, the present invention relates to automated and manual content verification of proposed Internet advertisements.

2. Description of the Related Art

In the field of Internet advertising, advertisers submit their advertisements to publishers for publishing on the Internet. Internet advertisers may be large or small, individuals or corporate entities, local or multi-national. Publishers are generally the owners or administrators of websites, and generally accept advertisements in exchange for money. Advertisements are usually banner advertisements, but also take the form of pop-up advertisements, paid placement among search results, etc.

Publishers are concerned with the content of advertisements that they publish. For example, advertisements for illegal merchandise (e.g., controlled substances), regulated merchandise (e.g., prescription medication), adult services (e.g., pornography), etc. may offend some Internet users and may be illegal in certain jurisdictions (e.g., China may prohibit pornographic advertisements). Publishers who publish advertisements in violation of the laws of a certain jurisdiction may face punishment, and publishers who publish advertisements that offend Internet users may realize a decline in traffic to their website or a decline in the number of users who purchase the publisher's goods and services.

In the area of search engine advertising, advertisers may want to advertise to users who search on a particular keyword. For example, a used car dealer may want to advertise to users who input the keyword “cars” into a search engine. However, because certain keywords such as “cars” are extensively searched upon every day, some advertisers may be motivated to have an advertisement be displayed to users who search for very broad terms, even if the advertisement is unrelated to the keyword, in order to maximize exposure to the advertisement. For example, a flower shop may want to increase the number of users who view its advertisements for Mother's Day bouquets by having the advertisements displayed to users who search on “cars”, because not as many users may search on “flowers”. Such an atmosphere can be irritating to Internet users, who are more likely to appreciate accurately targeted advertisements, especially when searching for information on a particular keyword. If users are constantly bombarded with irrelevant advertisements, they may be tempted to use a different search engine, which on a large scale would likely harm the search engine owner by reducing the amount of traffic and as a result, the revenue generated from advertising (which may be directly tied to the amount of traffic).

Therefore, publishers, and in particular, search engine operators, have a distinct need for a way to filter the content of advertisements to ensure that the above-described problems do not occur. At one extreme, a first implementation seemingly allows all advertisements to go live immediately, relying on users to report specific advertisements that are inappropriate. The first implementation seemingly then reviews the contents of the reported advertisement and takes action, i.e., removes the advertisement, if appropriate. The first implementation may perform some content review after an advertisement goes live in certain instances. At the other extreme, a second implementation seemingly requires that the content of all proposed advertisements be manually verified by a human being prior to going live. Unfortunately, both implementations have distinct disadvantages.

For a search engine operator using the first implementation's method of content review, an advertisement goes live immediately after submission and the operator must wait for an offensive advertisement to be reported by a user before reviewing the content thereof. Prior to being reported, hundreds or thousands of users may be offended by the advertisement and may simply choose to stop using the operator's search engine in favor of a competing search engine, rather than taking the time to report the offending advertisement. In that case, the search engine operator may not even be aware that users are rejecting the service in favor of the competition, but the end result is still the same: decreased traffic resulting in decreased revenue.

For a search engine operator using the second implementation's method of content review, the problem of decreased traffic is avoided because all advertisements are manually reviewed for content prior to going live. However, when such a system is implemented in a search engine, where limitless keywords are available for searching, it is possible that advertisements awaiting manual content review will become bottlenecked at the beginning of the manual content review process, where only a fixed number of human beings may be employed to conduct the manual reviews. Increasing the number of human being content reviewers increases the overhead, while decreasing the number of human being content reviewers increases the backlog of advertisements. Advertisers often want their advertisements to go live as soon as possible, and in the case of the florist (discussed above), if their Mother's Day bouquet advertisement is submitted close to Mother's Day, it might not make it through the manual content review process in time. If the advertisement is not approved until a week after Mother's Day, it is virtually worthless to the florist, and the florist will likely choose to advertise on another search engine in the future, resulting in lost revenue. Also, changes to the advertisement by the advertiser result in the advertisement being removed pending another manual content review. Again in the case of the florist, if a small change is made several days before Mother's Day, the bouquet advertisement may be taken down during a critical period of time.

Consequently, publishers are faced with the decision of whether to risk losing users, which results in less traffic and less bargaining power with advertisers, or whether to risk losing advertisers, which results in less advertising revenue. Therefore, a need exists in the industry to bridge the extremes between 100% manual content review before going live and instant live advertisements with manual content review afterwards.

### SUMMARY OF THE INVENTION

The present invention generally relates to content verification of network advertisements. Upon receiving a proposed network advertisement from an advertiser, a publisher determines whether to automatically approve the proposed advertisement for publishing, automatically reject the proposed advertisement from being published, or manually verify the content of the proposed advertisement prior to publishing based on a distribution channel of the proposed advertisement, a trust rating of the advertiser, a business rule, or expected traffic of a location at which the proposed advertisement is to appear.

If the distribution channel of the proposed advertisement requires extra caution, then the proposed advertisement is designated for manual review by a human being. If the advertiser's trust rating indicates that the advertiser is completely trustworthy, then the proposed advertisement is allowed to be published. If the proposed advertisement violates the business rule, then the proposed advertisement is prevented from being published. If the advertiser's trust rating indicates that the advertiser is completely untrustworthy, then the proposed advertisement is designated for manual review by a human being. If the advertiser's trust rating is above a predetermined good trust threshold, and if expected traffic of a location at which the proposed advertisement is to appear is below a predetermined low traffic threshold, then the proposed advertisement is allowed to be published. If the advertiser's trust rating indicates that the advertiser is not completely trustworthy, and if the expected traffic is above the low traffic threshold, then the proposed advertisement is designated for manual review by a human being. If the advertiser's trust rating indicates that the advertiser is not completely untrustworthy, and if the expected traffic is below a predetermined very low traffic threshold, then the proposed advertisement is allowed to be published. If the advertiser's trust rating is below the good trust threshold, and if the expected traffic is above the very low traffic threshold, then the proposed advertisement is designated for manual review by a human being.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a diagram illustrating the flow of an advertisement from advertiser to user, via a publisher, according to embodiments of the present invention;

FIG. 3 is a diagram illustrating publisher 704, according to embodiments of the present invention;

FIG. 4 is a flowchart illustrating the process of determining whether to automatically approve, automatically reject, or manually verify the content of an advertisement, according to embodiments of the present invention; and

FIG. 5 is a diagram illustrating data structure 1002, according to embodiments of the present invention.

### DETAILED DESCRIPTION OF THE INVENTION

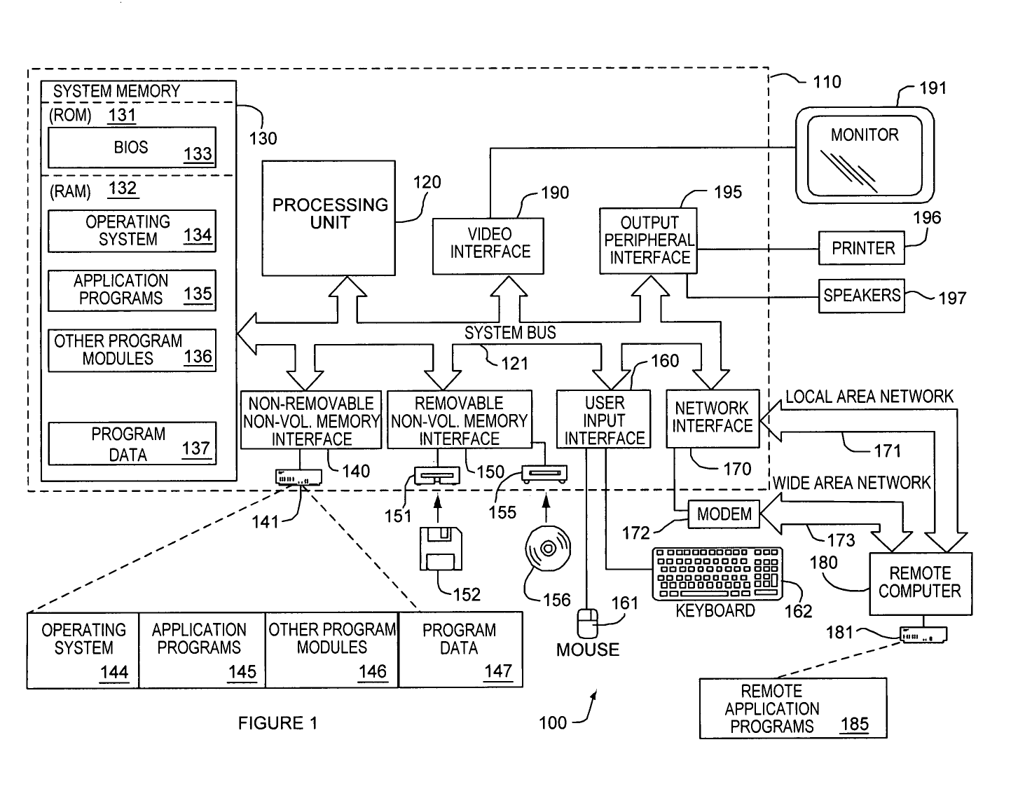

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Interconnect (PCI) bus also know as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable medial may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently begin operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drive and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different number here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user network interface 170, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

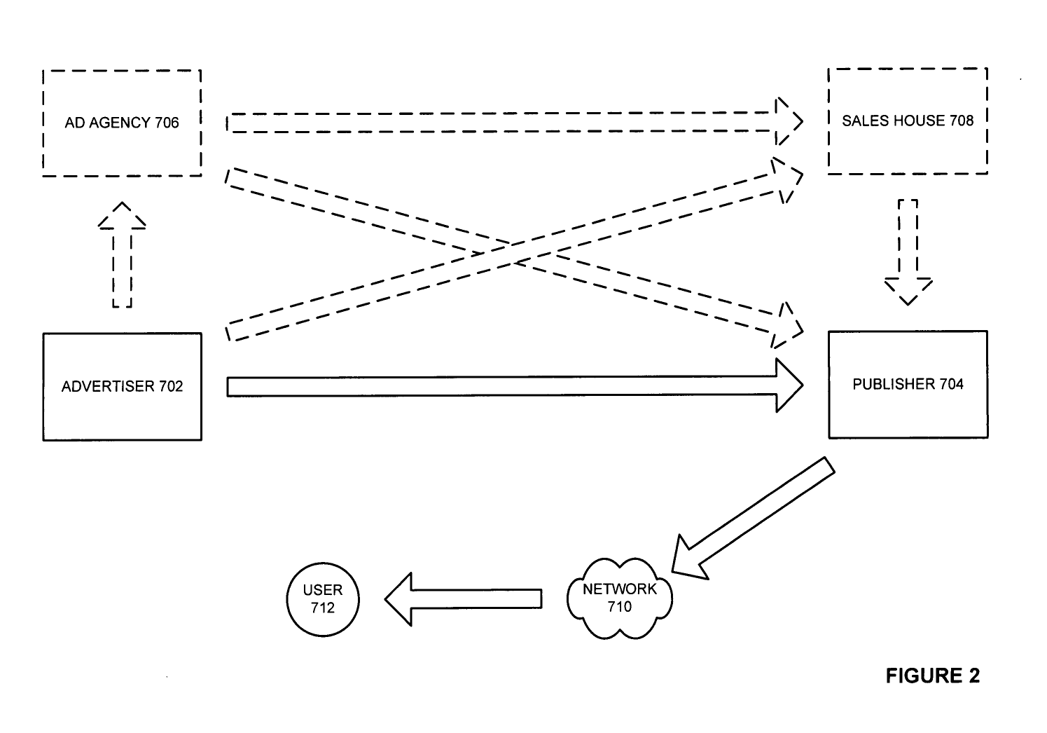

FIG. 2 illustrates the flow of an advertisement from advertiser to user, via a publisher, according to embodiments of the present invention. With reference to FIG. 2, advertiser 702, publisher 704, network 710, and user 712 are illustrated in relation to the flow of an advertisement from advertiser 702 to user 712 (using arrows). In an embodiment, advertiser 702 is any entity, individual or corporate, that desires to market goods or services to user 712 using network 710. Although only one advertiser 702 is illustrated in FIG. 2, embodiments of the present invention are not limited thereto, as any number of advertisers 702 may be present. In an embodiment, network 710 is the World Wide Web; however embodiments of the present invention are not limited thereto. For example, network 710 may be any other segment of the Internet or any other network, such as an email network, local area network 171, or wide area network 173 (as illustrated in FIG. 1). In an embodiment, user 712 is an individual user of network 710. In another embodiment, user 712 operates remote computer 180. Although only one user 712 is illustrated in FIG. 2, embodiments of the present invention are not limited thereto, as any number of users 712 (and related remote computers 180, if any) may be present. In various embodiments, advertiser 702 may target one, a group of, or all users 712 with a particular advertisement.

In an embodiment, publisher 704 is an individual or corporate search engine operator; however embodiments of the present invention are not limited thereto. For example, publisher 704 may be an internet content publisher, a simple website operator, a corporate network administrator, an internet service provider, an email provider, etc. In an embodiment, advertiser 702 utilizes the services of ad agency 706 (illustrated in FIG. 2 with dashed lines) to help design or create the advertisement and to negotiate with publisher 704 or sales house 708 (discussed below) on behalf of advertiser 702. However, the presence of ad agency is 706 is optional, as advertiser 702 may design and create its own advertisement and may negotiate its own deal. In another embodiment, sales house 708 (illustrated in FIG. 2 with dashed lines) represents publisher 704 and negotiates with ad agency 706 or advertiser 702. However, the presence of sales house 708 is optional, as publisher 704 may negotiate its own deal.

In an embodiment, when advertiser 702 develops its advertisement (with or without the help of ad agency 706), advertiser 702 submits an order to publisher 704 (with or without the help of ad agency 706 and sales house 708) for publishing of the advertisement, and negotiates with publisher 704 (with or without the help of ad agency 706 and sales house 708) for a fee to be paid to publisher 704. However, embodiments of the present invention are not limited to negotiated payment. For example, advertiser 702 or publisher 704 may make publicly available a standard advertising fee schedule to which the other party must assent, eliminating the need for negotiation. In another example, an auction model may be used. Also, embodiments of the present invention are not limited to a simple order. For example, advertiser 702 may wish to tie the advertisement to a particular keyword(s) in publisher 704's search engine, and would therefore bid on the particular keyword(s) in which it was interested.

At some point, the advertisement is submitted to publisher 704 (with or without the help of ad agency 706 or sales house 708) for publishing on network 710. In an embodiment, publisher 704 implements the present invention to automatically approve or reject advertisements based on certain criteria and to submit the rest for manual review (discussed in greater detail below).

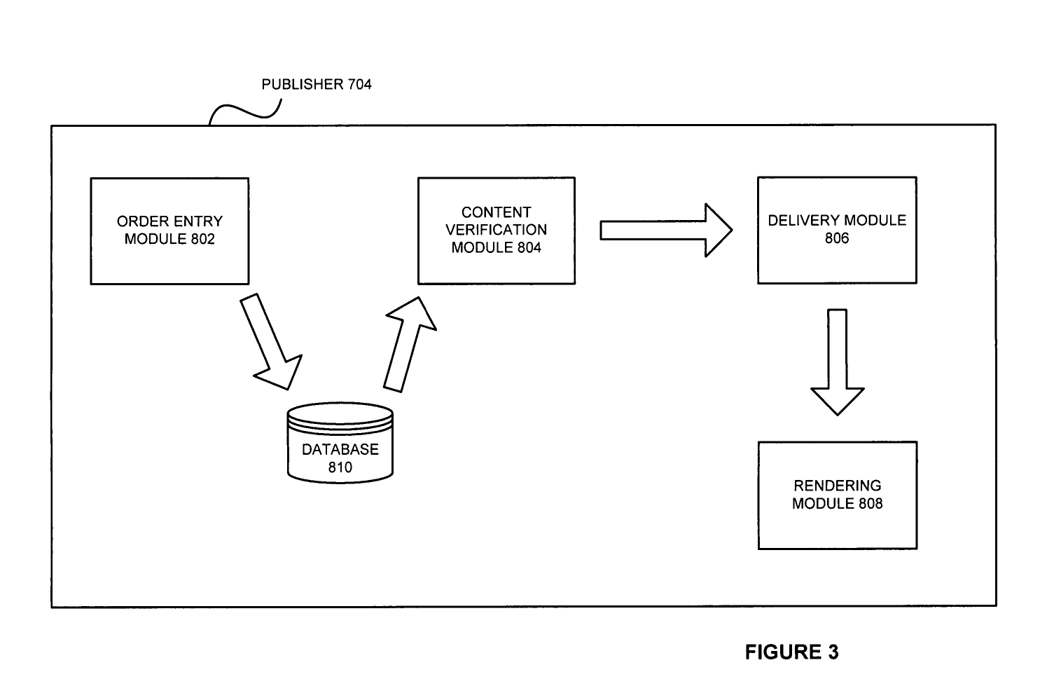

FIG. 3 illustrates publisher 704 in greater detail, according to embodiments of the present invention. With reference to FIG. 3, publisher 704 comprises order entry module 802, content verification module 804, delivery module 806, rendering module 808, and database 810, in an embodiment of the present invention. However, embodiments of the present invention are not limited to publisher 704 including everything illustrated in FIG. 3, as more or less may be included or may be structured differently. For example, database 810 might be a remote database. In another example, the functionality of delivery module 806 and rendering module 808 might be combined into a single unit. In yet another example, order entry module 802 may be outsourced.

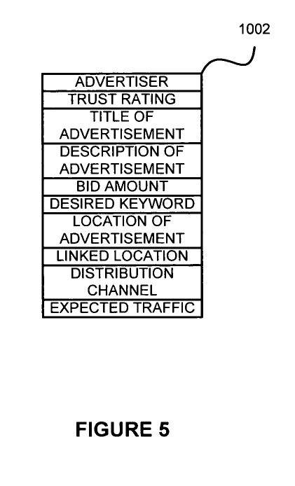

In an embodiment, order entry module 802 receives an order from advertiser 702 (as discussed in regard to FIG. 2, above). In an embodiment, as part of the ordering process, advertiser 702 submits information such as the advertiser's name, the desired keyword(s) (if using the search engine example), title of the advertisement, dollar amount to bid, description of the advertisement, display uniform resource locator (URL) of the advertiser's main site and the location to which the advertisement is linked, URL of the advertisement, the distribution channel, the start and end dates and times for the advertisement, etc. However, embodiments of the present invention are not limited to any particular set of information received from advertiser 702. This information may be stored in data structure 1002, as illustrated in FIG. 5, which is associated with the advertisement and which may be stored in database 810. However, embodiments of the present invention are not limited to the existence of or any particular contents of data structure 1002. For example, data structure 1002 may also comprise other distribution channels, the advertiser's industry, a relevance score of the advertisement, content categories (e.g., gambling, alcohol, etc.), whether a keyword is to be broad or narrow (e.g., “shoes” keyword returns “red shoes”, “green shoes”, and “shoes” if broad, and only the latter if narrow), etc. In an embodiment, database 810 stores information on advertiser 702, and if there are multiple advertisers 702, database 810 stores information on all of the advertisers 702. For example, in an embodiment, database 810 stores a trust rating of advertiser 702 (discussed in greater detail below). In an embodiment, content verification module 804 accesses the information stored in database 810 and automatically approves or rejects advertisements based on certain criteria and submits the rest for manual review (discussed in greater detail below). In an embodiment, delivery module 806 determines the timing and manner in which the approved advertisements are to be shown. For example, delivery module 806 determines that a particular approved advertisement will be a banner ad that rotates among 10 other banner ads. In an embodiment, rendering module 808 determines how to present an approved advertisement. For example, rendering module 808 sets certain specifications for the advertisement, including the color scheme, size, animation, and delivery method (e.g., web page, email, etc.), etc.

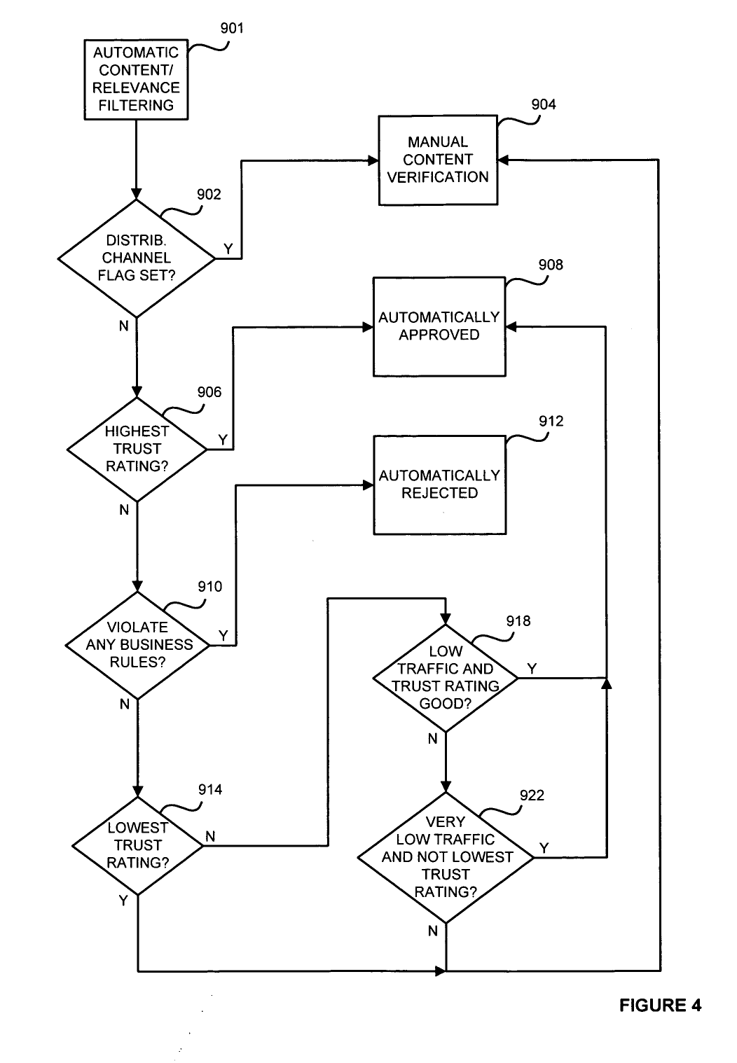

FIG. 4 illustrates the process of determining whether to automatically approve, automatically reject, or manually verify the content of an advertisement, according to embodiments of the present invention. With reference to FIG. 4, various operations are performed in order to partially automate the content review process. In an embodiment, as a preliminary operation, automatic filtering for content and relevance is performed (901) by other modules and components, which are well-known in the art, and which may be provided by third parties. Such modules and components may be integrated into content verification module 804 or may be separate and distinct from content verification module 804. In an embodiment, the automatic content filtering component/module examines the content of the advertisement or the content of a website that is linked from the advertisement, and filters out predetermined subject matter, e.g., weapons and drugs. In another embodiment, the automatic relevance filtering component/module examines the content of the advertisement or the content of a website that is linked from the advertisement, as well as the requested keyword with which the advertisement is to be associated, assigns a relevance score to the advertisement, and filters out advertisements that do not meet a predetermined threshold. For example, if advertiser 702 was the florist in the above example and was attempting to associate its advertisement for Mother's Day bouquets with the “cars” keyword on a search engine, the relevance score would be relatively low, because flowers are not very related to cars.

If the advertisement passes the automatic content and relevance filtering operation, i.e., is not filtered out, its distribution flag is examined (902). As alluded to above, advertiser 702 submits, for each advertisement, information about the distribution channel. For example, if the intended markets are the United States and China, advertiser 702 designates both countries during the ordering procedure. Embodiments of the present invention are not limited to countries being the only market distinction, as towns, cities, states, regions, continents, etc. may be designated. In addition, embodiments of the present invention are not limited to geographic designations only, as any other distribution channel is applicable. For example, other distribution channels may be women's pages, sports pages, email, search, etc. Further, embodiments of the present invention are not limited to a single distribution channel and associated flag. As part of data structure 1002, a distribution channel flag may be set by publisher 704 according to the designation of distribution channels by advertiser 702. However, embodiments of the present invention are not limited to a flag, as any indicator may be used. For example, an numerical value or range may be assigned. If the distribution channel is determined by publisher 704 to be one for which a high level of caution must be exercised, then publisher 704 sets the distribution channel flag to indicate that any advertisements must be manually verified for content so that inappropriate advertisements do not go live in the distribution channel requiring extra caution. In the example mentioned above, where the United States and China are designated as the distribution channels, if China is determined to be a distribution channel that requires extra caution, then publisher 704 would set the distribution channel flag for the advertisement, regardless of any other factors. If neither the United States nor China were distribution channels that require extra caution, then publisher 704 would not set the distribution channel flag.

If the distribution channel flag is set (indicating that the distribution channel is one for which extra caution is required), then the advertisement is designated for manual content verification (904). Therefore, any advertisements that are intended for distribution channels that require extra caution are manually reviewed for content by a human being. If the advertisement is intended for distribution channels that do not require extra caution, then the distribution channel flag will not be set. In an embodiment, each possible market is given a default distribution channel rating indicating that “all manual” content verification is not required. However, embodiments of the present invention are not limited to any particular default distribution channel ratings or even any default ratings at all.

If the distribution channel flag is not set, then advertiser 702's trust rating is examined (906). As another part of data structure 1002, advertiser 702's trust rating is set by publisher 704 based on advertiser 702's past history. In an embodiment, the trust rating is a numerical rating, e.g., 5 out of a possible 6. In an embodiment, advertiser 702 is given a default trust rating, which may be later modified by advertiser 702's expected behavior, prior to establishing any history with publisher 704. However, embodiments of the present invention are not limited to numbers or any specific defaults, as any rating and default system (or no default) may be used. For example, a series of flags may be used to indicated whether advertiser 702 has a particular trust rating. In an embodiment, if advertiser 702 has a very good history of submitting relevant, appropriate ads with few spelling errors or few objectionable qualities (all caps, too many exclamation points, animation, etc.), it will likely be given a high trust rating. In another embodiment, if advertiser 702 has a very poor history of submitting relevant, appropriate ads with many spelling errors or many objectionable qualities, it will likely be given a low trust rating. In an embodiment, zero to five is used as the range of trust ratings, zero being completely trustworthy and five being completely untrustworthy. However, embodiments of the present invention are not limited to such a range, as any range may be used. If advertiser 702 has a trust rating indicating that it is completely trustworthy, then any advertisements that it submits (that do not have the distribution channel flag set, as discussed above) will be automatically approved (908).

If the distribution flag is not set and if advertiser 702 has a trust rating of anything less than completely trustworthy (one to five, in the example above), then the advertisement and advertiser 702 are checked against publisher 704's business rules (910). In an embodiment, publisher 704 stores any number of business rules (or none at all) in database 810. However, embodiments of the present invention are not so limited, as the business rules may be stored or catalogued anywhere, even separately from publisher 704. In an embodiment, publisher 704's business rules relate to the business or industry in which advertiser 702 operates. So, in relation to distribution channels, which are not business or industry specific, business rules may be specific to the business or industry, the target market, or the content. For example, returning to the search engine scenario, publisher 704 may establish a business rule for gambling-related businesses that allows such businesses to advertise on the keyword “blackjack” but not on the keyword “Las Vegas”. A user who searches for “blackjack” is much more likely to be interested in gambling than a user who searches for “Las Vegas”, because the latter user may simply be looking for inexpensive vacation destinations (regardless of gambling), hotel information for an upcoming business trip or convention, etc. Publisher 704, by establishing such a business rule, can avoid offending the latter user with gambling advertisements, when the user's intended search results may not necessarily be gambling related. However, for the former user who is much more likely to be in search of gambling information, gambling advertisements are much more likely to be acceptable to that user. In another example, publisher 704 may set up a business rule that prevents any advertisements that relate to the sale of illegal drugs. In yet another example, publisher 704 may set up a business rule that allows advertisements for prescription medication only from entities that are FDA-approved to sell prescription drugs online. However, the present invention is not limited to the foregoing examples of business rules, as any business rule may be established. If the advertisement or advertiser 702 violates any business rules, then it is automatically rejected (912).

If the distribution channel flag is not set and if advertiser 702 has a trust rating of anything less than completely trustworthy and if no business rules are violated, then advertiser 702's trust rating is again examined (914). If advertiser 702 has a trust rating indicating that it is completely untrustworthy (five, in the example above), then the advertisement is designated for manual content verification (904).

If the distribution channel flag is not set and if advertiser 702 does not have a trust rating indicating that it is completely trustworthy or completely untrustworthy and if no business rules are violated, then advertiser 702's trust rating is again examined, along with the expected traffic (918). If advertiser 702's trust rating is above a predetermined threshold, it is considered to be “good”. For example, publisher 704 may designate a “good trust” threshold at 2 (using the zero to five example above), and a trust rating of 1 or 2 would be considered “good”. However, embodiments of the present invention are not limited to any particular threshold. In addition, embodiments of the present invention are not limited to a threshold at all, as a curve or clustering technique between trust and expected traffic may be used. Continuing with the example above, if advertiser 702 has a trust rating of 1, it is not considered to be completely trustworthy (trust rating of zero) or completely untrustworthy (trust rating of five), but because its trust rating is above the “good trust” threshold of 2, advertiser 702 is determined to have a “good” trust rating. In an embodiment, the expected traffic is stored in data structure 1002.

In an embodiment, the expected traffic is some measurement of the number of views expected over a set period of time. In the search engine example, expected traffic may be the anticipated number of searches on a particular keyword per day or the percentage of total searches on that keyword (based on historical numbers). In the newsletter example, expected traffic may be the number of newsletter subscribers per issue. In simple web page example, expected traffic may be the average daily page views. However, embodiments of the present invention are not limited to such expected traffic examples, as any measurement of expected traffic and time period may be used. If the expected traffic is below a predetermined threshold, it is determined to be “low”. For example, publisher 704 may designate a “low traffic” threshold of 10 keyword queries per month (in the search engine example), and an expected traffic measurement of 5 keyword queries per month would be considered “very low”. However, embodiments of the present invention are not limited to any particular threshold. Therefore, if expected traffic is below the “low traffic” threshold and if advertiser 702's trust rating is above the “good trust” threshold and if the distribution channel flag is not set and if advertiser 702 does not have a trust rating indicating that it is completely trustworthy or completely untrustworthy and if no business rules are violated, then the advertisement is automatically approved (908).

If the distribution channel flag is not set and if advertiser 702 does not have a trust rating indicating that it is completely trustworthy or completely untrustworthy and if no business rules are violated but the advertiser 702's trust rating is not above the “good trust” threshold, then the expected traffic and trust rating are reexamined (922). Publisher 704 may set another “very low traffic” threshold below the “low traffic” threshold. If advertiser 702 cannot achieve the “good trust” threshold but is not completely untrustworthy (5 in the above example) and the expected traffic is below the “very low traffic” threshold, then the advertisement is automatically approved (908). If advertiser 702 cannot achieve the “good trust” threshold but is not completely untrustworthy (5 in the above example), but the expected traffic is above the “very low traffic” threshold, then the advertisement is designated for manual content verification (904). Utilizing the “very low traffic” threshold allows publisher 704 to ‘trust’ advertisements from advertiser 702 if the expected traffic is low enough to not have a significant negative impact if the advertisement turns out to be inappropriate.

As a result of manual content verification (904), an advertisement is automatically approved or rejected. In an embodiment, once an advertisement is approved, either manually (904) or automatically (908), it is able to go live on publisher 704 via delivery module 806 and rendering module 808 (as applicable). In an embodiment, if an advertisement is rejected, either manually or automatically (912), advertiser 702 is notified of the rejection. However, embodiments of the present invention are not limited thereto, as any resulting action may be taken by publisher 704. For example, if an advertisement is rejected, the advertisement may be returned to advertiser 702, the advertisement may be stored for record keeping purposes, advertiser 702's trust rating may be adjusted, other entities may be notified, etc.

Embodiments of the present invention are not limited to determinations of above or below a threshold, as determinations of ‘at or above’ or ‘at or below’ a threshold may also be used. In addition, embodiments of the present invention are not limited to requiring publisher 704 to consider all of the distribution channel, trust rating, business rules, and expected traffic, as publisher 704 may selectively use any of the criteria as appropriate. In an embodiment, flags and ratings are set by a human being. However, embodiments of the present invention are not so limited, as programs may be written to set flags and ratings automatically.

Therefore, by implementing the present invention, publisher 704 may reduce overhead expenses associated with a large manual content verification staff and may rely on certain criteria to automatically accept or reject certain advertisements, leaving a smaller number of advertisements for manual verification. Also, publisher 704 may avoid alienating users by preventing inappropriate advertisements from going live. In the search engine example, approximately 40 million keywords are envisioned, and managing paid advertisements for each keyword would be a daunting task without the use of the present invention. In addition, with advertisers numbering in the hundreds of thousands, tracking each advertiser would be a burdensome task, and large advertisers who are generally trustworthy would prefer a system in which they can realize some sort of benefit, e.g., speed through the verification process.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The invention claimed is:

1. A computer-implemented method of reviewing network advertisements for publishing, comprising:
receiving a proposed network advertisement from an advertiser; and
determining whether to automatically approve the proposed advertisement for publishing, automatically reject the proposed advertisement from being published, or manually verify the content of the proposed advertisement prior to publishing based on a distribution channel of the proposed advertisement, a trust rating of the advertiser, a business rule, or expected traffic of a location at which the proposed advertisement is to appear.

2. The method of claim 1, further comprising:
setting the advertiser's trust rating.

3. The method of claim 2, wherein the advertiser's trust rating is based on the advertiser's historical advertisement content.

4. The method of claim 1, further comprising:
setting the business rule.

5. The method of claim 1, further comprising:
determining the expected traffic of the location.

6. The method of claim 1, further comprising:
determining whether the distribution channel of the proposed advertisement requires extra caution, and if so, then designating the proposed advertisement for manual review by a human being.

7. The method of claim 6, further comprising:
receiving a designation of the distribution channel of the proposed advertisement from the advertiser.

8. The method of claim 7, further comprising:
setting a distribution channel flag of the proposed advertisement if the distribution channel of the proposed advertisement requires extra caution.

9. The method of claim 1, further comprising:
determining whether the advertiser's trust rating indicates that the advertiser is completely trustworthy, and if so, then allowing the proposed advertisement to be published.

10. The method of claim 1, further comprising:
determining whether the proposed advertisement violates the business rule, and if so, then preventing the proposed advertisement from being published.

11. The method of claim 1, further comprising:
determining whether the advertiser's trust rating indicates that the advertiser is completely untrustworthy, and if so, then designating the proposed advertisement for manual review by a human being.

12. The method of claim 1, further comprising:
determining whether the advertiser's trust rating is above a predetermined good trust threshold, and whether expected traffic of a location at which the proposed advertisement is to appear is below a predetermined low traffic threshold, and if so, then allowing the proposed advertisement to be published.

13. The method of claim 12, further comprising:
determining whether the advertiser's trust rating indicates that the advertiser is not completely trustworthy, and whether the expected traffic is above the low traffic threshold, and if so, then designating the proposed advertisement for manual review by a human being.

14. The method of claim 12, further comprising:
determining whether the advertiser's trust rating indicates that the advertiser is not completely untrustworthy, and whether the expected traffic is below a predetermined very low traffic threshold, and if so, then allowing the proposed advertisement to be published, wherein the very low traffic threshold is lower than the low traffic threshold.

15. The method of claim 14, further comprising:
determining whether the advertiser's trust rating is below the good trust threshold, and whether the expected traffic is above the very low traffic threshold, and if so, then designating the proposed advertisement for manual review by a human being.

16. A machine-readable medium that provides instructions for reviewing network advertisements for publishing, which, when executed by a machine, cause the machine to perform operations comprising:
receiving a proposed network advertisement from an advertiser; and
determining whether to automatically approve the proposed advertisement for publishing, automatically reject the proposed advertisement from being published, or manually verify the content of the proposed advertisement prior to publishing based on a distribution channel of the proposed advertisement, a trust rating of the advertiser, a business rule, or expected traffic of a location at which the proposed advertisement is to appear.

17. The machine-readable medium of claim 16, wherein the instructions cause the machine to perform operations further comprising:
setting the advertiser's trust rating.

18. The machine-readable medium of claim 17, wherein the advertiser's trust rating is based on the advertiser's historical advertisement content.

19. The machine-readable medium of claim 16, wherein the instructions cause the machine to perform operations further comprising:
setting the business rule.

20. The machine-readable medium of claim 16, wherein the instructions cause the machine to perform operations further comprising:
determining the expected traffic of the location.

21. The machine-readable medium of claim 16, wherein the instructions cause the machine to perform operations further comprising:
determining whether the distribution channel of the proposed advertisement requires extra caution, and if so, then designating the proposed advertisement for manual review by a human being.

22. The machine-readable medium of claim 21, wherein the instructions cause the machine to perform operations further comprising:
receiving a designation of the distribution channel of the proposed advertisement from the advertiser.

23. The machine-readable medium of claim 22, wherein the instructions cause the machine to perform operations further comprising:
setting a distribution channel flag of the proposed advertisement if the distribution channel of the proposed advertisement requires extra caution.

24. The machine-readable medium of claim 16, wherein the instructions cause the machine to perform operations further comprising:
determining whether the advertiser's trust rating indicates that the advertiser is completely trustworthy, and if so, then allowing the proposed advertisement to be published.

25. The machine-readable medium of claim 16, wherein the instructions cause the machine to perform operations further comprising:
determining whether the proposed advertisement violates the business rule, and if so, then preventing the proposed advertisement from being published.

26. The machine-readable medium of claim 16, wherein the instructions cause the machine to perform operations further comprising:
determining whether the advertiser's trust rating indicates that the advertiser is completely untrustworthy, and if so, then designating the proposed advertisement for manual review by a human being.

27. The machine-readable medium of claim 16, wherein the instructions cause the machine to perform operations further comprising:
determining whether the advertiser's trust rating is above a predetermined good trust threshold, and whether expected traffic of a location at which the proposed advertisement is to appear is below a predetermined low traffic threshold, and if so, then allowing the proposed advertisement to be published.

28. The machine-readable medium of claim 27, wherein the instructions cause the machine to perform operations further comprising:
determining whether the advertiser's trust rating indicates that the advertiser is not completely trustworthy, and whether the expected traffic is above the low traffic threshold, and if so, then designating the proposed advertisement for manual review by a human being.

29. The machine-readable medium of claim 27, wherein the instructions cause the machine to perform operations further comprising:
determining whether the advertiser's trust rating indicates that the advertiser is not completely untrustworthy, and whether the expected traffic is below a predetermined very low traffic threshold, and if so, then allowing the proposed advertisement to be published,
wherein the very low traffic threshold is lower than the low traffic threshold.

30. The machine-readable medium of claim 29, wherein the instructions cause the machine to perform operations further comprising:
determining whether the advertiser's trust rating is below the good trust threshold, and whether the expected traffic is above the very low traffic threshold, and if so, then designating the proposed advertisement for manual review by a human being.

31. A computer-readable medium having stored thereon a data structure, comprising:
a trust rating data field comprising data representing a trust rating of an advertiser;
a distribution channel data field comprising data representing a distribution channel of a network advertisement proposed by the advertiser; and
an expected traffic data field comprising data representing expected traffic that would view the advertisement.

32. The computer-readable medium of claim 31, wherein the distribution channel field is a flag.

33. The computer-readable medium of claim 31, further comprising:
an advertiser data field comprising a name of the advertiser.

34. The computer-readable medium of claim 31, further comprising:
a title data field comprising a title of the advertisement.

35. The computer-readable medium of claim 31, further comprising:
a description data field comprising a description of the advertisement.

36. The computer-readable medium of claim 31, further comprising:
a bid amount data field comprising an amount that the advertiser is willing to bid for the advertisement.

37. The computer-readable medium of claim 31, further comprising:
a keyword data field comprising a keyword with which the advertiser desires to associate the advertisement.

38. The computer-readable medium of claim 37, further comprising:
a keyword breadth data field comprising a breadth of the keyword.

39. The computer-readable medium of claim 31, further comprising:
an advertisement location data field comprising a location of the advertisement.

40. The computer-readable medium of claim 31, further comprising:
a linked location data field comprising a location to which the advertisement links.

41. The computer-readable medium of claim 31, further comprising:
an industry data field comprising an industry of the advertiser.

42. The computer-readable medium of claim 31, further comprising:
a relevance data field comprising a relevance score of the advertisement.

43. The computer-readable medium of claim 31, further comprising:
a content data field comprising a content category of the advertisement.
